(19) United States
(12) Patent Application Publication
(10) Pub. No.: US 2007/0210926 A1
(43) Pub. Date: Sep. 13, 2007

(54) Apparatus and Method for Communicating Cues During a Musical Performance

(76) Inventor: Jon P. Chavez, St. Charles, IL (US)

Correspondence Address: MILLER, MATTHIAS & HULL, ONE NORTH FRANKLIN STREET, SUITE 2350, CHICAGO, IL, 60606, US

(21) Appl. No.: 11/683,918

(22) Filed: Mar. 8, 2007

Related U.S. Application Data
(60) Provisional application No. 60/780,158, filed on Mar. 8, 2006.

(51) Int. Cl. G08B 23/00; G08B 1/08; G08C 19/00

(52) U.S. Cl. 340/573.1; 340/539.11; 340/825.72

(57) ABSTRACT

An apparatus for communicating cues from a music director to one or more musicians includes a transmitter unit having a housing, a transmitter controller disposed in the housing, and a plurality of input devices operably coupled to the transmitter controller. At least one transmitter is operably coupled to the controller, and the controller is capable of sensing actuation of an input device selected from the plurality of input devices and operating the transmitter to send a cue signal associated with the input device. At least one receiver unit is provided including a housing, a receiver controller disposed in the housing, a receiver operably coupled to the receiver controller and adapted to receive the cue signal, and a plurality of visual indicators operably coupled to the controller. The receiver controller is adapted to activate a visual indicator selected from the plurality of visual indicators that corresponds to the cue signal.

### CROSS-REFERENCE TO RELATED APPLICATION

This application claims the benefit of provisional patent application No. 60/780,158, filed on Mar. 8, 2006, which is incorporated by reference herein.

### FIELD OF THE DISCLOSURE

The present disclosure generally relates to cueing systems, and more particularly to systems for communicating cues from a music director to one or more musicians.

### BACKGROUND OF THE DISCLOSURE

Cueing systems have been implemented in various types of performing arts. There is an inherent need to alert actors, musicians, news anchors, dancers, and various other public performers to the fact that they must initiate action. For example, oral cueing has conventionally been used during the production of films. While satisfactory for movie production, oral cueing is decidedly less suitable for other performances, such as live theatrical or musical performances.

More recently, wireless systems have been disclosed that are capable of broadcasting cues to multiple performers. U.S. Pat. No. 6,462,662 to Rondow et al. discloses methods and apparatus for remote cueing during performing arts. The system disclosed by Rondow et al. is particularly suited for use during movie production, and includes a master cue controller capable of communicating to multiple disk-shaped cueing devices. The cueing devices are sized and designed to be concealed such as within the clothing of the performer. The controller includes a microcomputer device and memory that are operably coupled to a keyboard input and a flat-panel display. Each cueing device is given a unique identifier so that a cue command may be communicated to only one or a subset of the cue devices. These known cue systems are overly complex and expensive for use in simple musical productions, such as those performed in churches.

### BRIEF DESCRIPTION OF THE DRAWINGS

FIG. 1 is a perspective view of a cue transmitting unit attached to a microphone, in accordance with the present disclosure;

FIG. 2 is a top plan view of the cue transmitter of FIG. 1;

FIG. 3 is an end view of the cue controller of FIG. 1;

FIG. 4 is a side elevation view of the cue controller of FIG. 1;

FIG. 5 is a front view of a receiver unit for use with the cue transmitter of FIG. 1;

FIG. 6 is a top plan view of the receiver unit of FIG. 5; and

FIG. 7 is a side elevation view of the receiver unit of FIG. 5.

While the present disclosure is susceptible to various modifications and alternative constructions, certain illustrative embodiments thereof have been shown in the drawings and will be described below in detail. It should be understood, however, that there is no intention to limit the present disclosure to the specific forms disclosed, but on the contrary, the intention is to cover all modifications, alternative constructions, and equivalents falling within the spirit and scope of the present invention.

### DETAILED DESCRIPTION

A system for communicating cues from a music director to one or more musicians is disclosed herein with reference to a live musical production. The system includes a transmitter unit for generating signals corresponding to the desired musical cue and one or more receiver units capable of receiving the cue signals and generating a corresponding visual indication of the desired cue. The system is described in the context of a musical production in a church, wherein the transmitter unit is adapted for attachment to a microphone used by a music director and the receiver units are adapted for attachment to music stands used by the musicians. It will be appreciated, however, that the transmitter and receiver units may be used in other arrangements, and that the cueing system may be used to assist other types of live musical performances other than in a church setting.

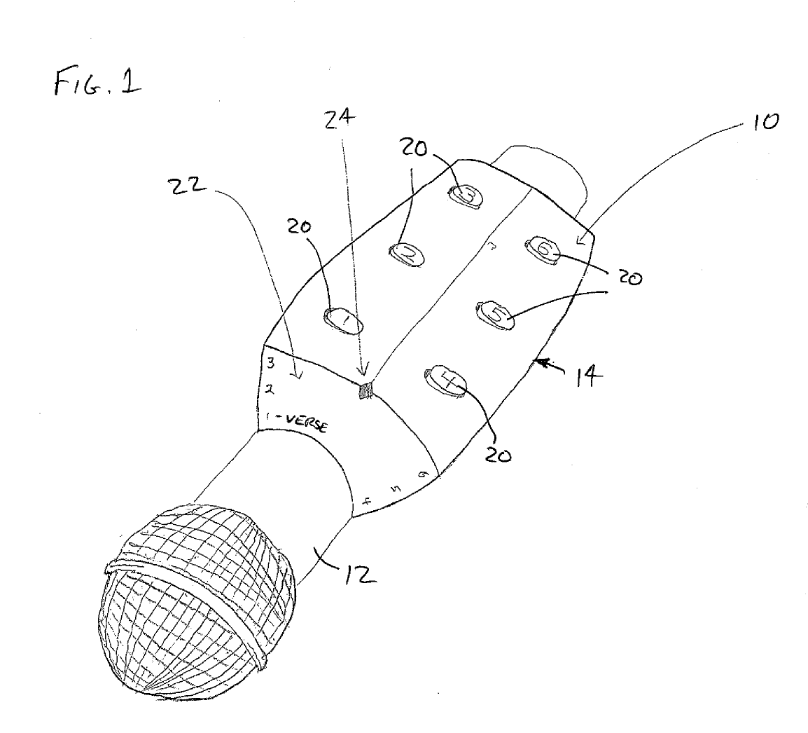

FIG. 1 illustrates one embodiment of a transmitter unit 10 in accordance with the present disclosure. The transmitter unit 10 is adapted for attachment to a standard microphone 12. Accordingly, the transmitter unit includes a housing 14 with a bottom surface 16 shaped to closely fit an exterior of the microphone 12. The housing 14 also has an overall size that is sufficiently small so as not to be overly cumbersome to hold either alone or when attached to a supporting structure, such as the microphone 12. A top surface 18 of the housing 14 carries a plurality of input devices, such as buttons 20. In the illustrated embodiment, an on/off indicator 24 is provided for indicating whether or not the transmitter unit 10 is operative.

Each button 20 may have a unique visual identifier, such as a number, printed thereon. A top surface 18 of the housing 14 may include a reference key 22 that lists each unique identifier from the buttons 20 and may include associated text identifying a specific musical cue associated with that particular button. For example, the number “1” may be printed on one of the buttons 20 as the unique identifier for that button, and the reference key may include an entry “1—VERSE” to remind the user that the button with the number “1” is associated with a cue for the musicians to play the verse of a song.

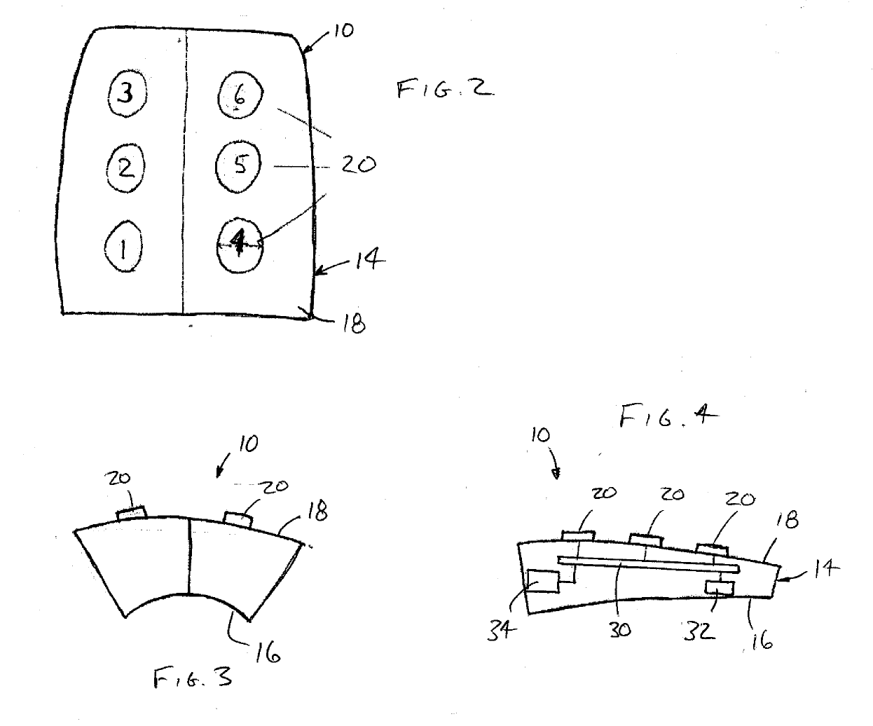

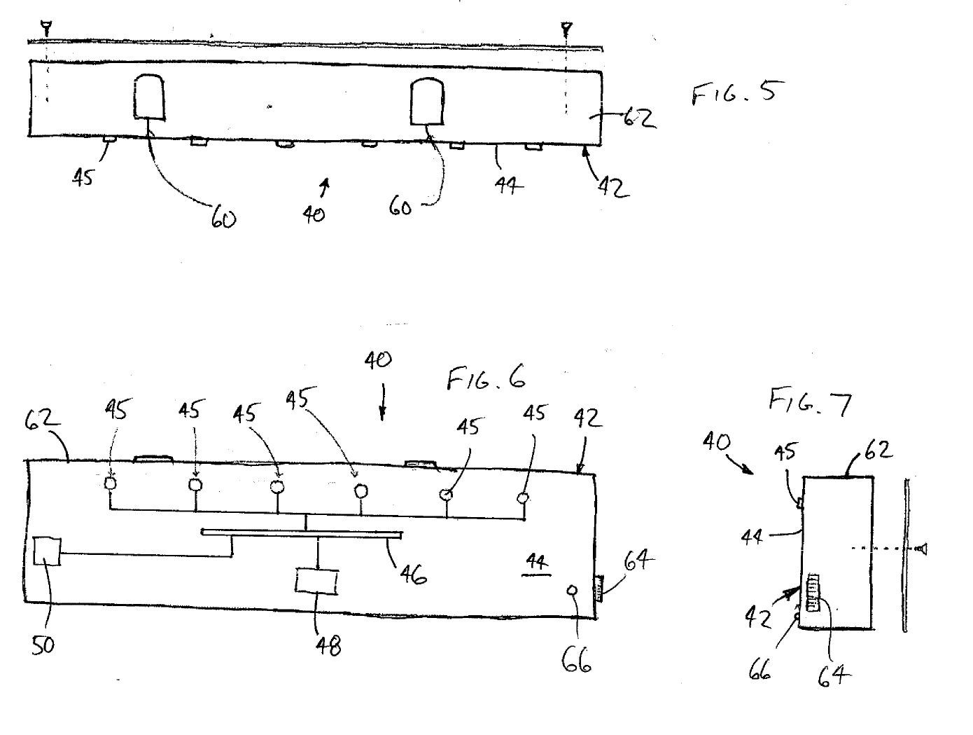

To better fit a user's hand when attached to a microphone, the housing 14 preferably has a low profile with a curved contour, as best shown in FIG. 3. The distance between the bottom and top surface 16, 18 may be less than 1 inch and is preferably no more than 0.75 inches. The bottom surface 16 is curved to match the shape of a standard microphone. The top surface 18 is also preferably curved to better fit a user's hand.

The transmitter unit 10 includes a controller for detecting when a button 20 has been actuated and for generating a signal associated with that button corresponding to a particular musical cue associated therewith. As schematically shown in FIG. 4, the transmitter unit includes a circuit board 30 operatively coupled to each of the buttons 20. A power source 32 is connected to the circuit board 30. A transmitter 34 is also operatively coupled to the circuit board 30 and is adapted to generate electronic signals associated with the various buttons 20. The electronic signal may be in any known form, including wired or wireless methods (e.g., infra red, RF, or other interface).

A receiver unit 40 is illustrated in FIG. 7. The receiver unit 40 includes a housing 42 with a front face 44 carrying a series of visual indicators 45, such as LEDs. A circuit board 46 is disposed inside the housing 42 and is operably coupled the visual indicators 45. A power source 48, such as a battery, is coupled to the circuit board 46. A receiver 50 is also disposed in the housing 42 and operably coupled to the circuit board 46. The receiver 50 is adapted to receive the electronic signals generated by the transmitter unit 10 and forward them to the circuit board 46, which then illuminates the visual indicator associated with the cue signal sent by the transmitter. Reference information, such as a number key or text, may be provided adjacent each LED so that a musician can readily interpret what musical cue has been communicated. Clips 60 may be attached to a top wall 62 of the housing to facilitate attachment of the receiver unit 40 near the musician. For example, the clips 60 may be generally horizontally oriented so that the receiver unit 40 may be easily attached to a music stand. The receiver unit 40 may also include an on/off switch 64 and a on/off indicator light 66.

In the illustrated embodiment, the transmitter unit 10 and receiver unit 40 are capable of communicating six unique cues. The present disclosure contemplates systems capable of transmitting both fewer and more than six cues. In addition, the music director may customize the system to include a custom set of cues. For example, button no. 1 may be a verse button indicating that the musician is to play the verse of a song. Button no. 2 may be a chorus button, button no. 3 may be a bridge button, button no. 4 may be a tag button, button no. 5 may be a drummer solo button, and button no. 6 may be a guitarist solo button. The receiver units 40 may include a visual indicator 45 for each of the particular cues, with reference information identifying the directive with which each visual indicator is associated. The particular cues listed herein are provided merely for illustration, as other cues may be communicated by the disclosed system. Furthermore, the cues may be provided in any order and associated with the buttons as desired.

The system disclosed herein is particularly advantageous for use during the live performance of musical productions. Songs have several identifiable, and often repeating, musical elements, such as a verse, a chorus, a bridge, a tag, and the like. In addition, non-repetitive musical elements may be incorporated into a song, such as a guitar, drum, or other solo. These elements may be pre-planned, and therefore structured elements, or may be unstructured elements such as free form or unscripted solos. In either event, there are a finite number of musical elements common to most songs or performances, and each musician is familiar with these various elements. The present system is capable of communicating directions, in a non-audible way, to play one or a series of these musical elements, and therefore can assist a music director during a live musical performance.

While the transmitter unit is described herein for attachment to a microphone, it may be provided in alternative forms. For example, the transmitter unit may be provided completely separate from the microphone, and may be adapted to be manipulated either by hand or by foot, such as in the form of a foot pedal.

In addition, while reference has been made herein to the production of a live music performance, it will be appreciated that the cuing apparatus may be used in other applications. For example, the cuing system may be used to direct musicians while recording music in a studio or other location, which may not technically be a live performance. Still further, the system may be used to cue a change in a visual display that is either related or unrelated to a musical performance. For example, an overhead projector may be employed to display pictures, text, or other graphics to an audience. A director may wish to repeatedly display a specific graphic, show the graphics in a given sequence, or show the graphics out of sequence. A projector operator may have a receiver unit that provides visual indicators corresponding to cue signals delivered by a transmitter unit used by the director. The cue signals may relate to directions to display a graphic selected from the set of graphics, as requested by the director. These graphics may be provided to enhance a musical performance, and therefore may use the same cues noted above, where a specific graphic may be related to the chorus of the song, another to a verse, and so on. Alternatively, the graphics may be unrelated to a musical performance but instead are provided in association with a sermon or other live or recorded presentation.

While the foregoing was written with reference to specific examples and embodiments, it is to be understood that the scope of the disclosure is not limited thereby. Instead, the detailed description is provided to satisfy best mode and enablement requirements while providing support for any and all claim which may issue herefrom.

What is claimed:

1. Apparatus for communicating cues from a music director to one or more musicians, comprising:
a transmitter unit including a housing, a transmitter controller disposed in the housing, a plurality of input devices operably coupled to the transmitter controller, and at least one transmitter operably coupled to the controller, wherein the controller is capable of sensing actuation of an input device selected from the plurality of input devices and operating the transmitter to send a cue signal associated with the input device;
at least one receiver unit including a housing, a receiver controller disposed in the housing, a receiver operably coupled to the receiver controller and adapted to receive the cue signal, and a plurality of visual indicators operably coupled to the controller, wherein the receiver controller is adapted to activate a visual indicator selected from the plurality of visual indicators that corresponds to the cue signal.

2. The apparatus of claim 1, in which the cues comprise directions to perform musical elements.

3. The apparatus of claim 1, in which the musical elements include structured and unstructured elements.

4. The apparatus of claim 1, in which each input device carries a unique identifier, and in which the transmitter housing carries a reference key cross referencing each unique identifier with a selected musical cue.
